(19) United States
(12) Patent Application Publication
(10) Pub. No.: US 2020/0026939 A1
(43) Pub. Date: Jan. 23, 2020

(54) ELECTRONIC DEVICE AND METHOD FOR CONTROLLING THE SAME

(71) Applicant: LG ELECTRONICS INC., Seoul (KR)

(72) Inventors: Sooyoung SIM, Seoul (KR); Kokeun KIM, Seoul (KR); Sungjin KIM, Seoul (KR); Jinsung PARK, Seoul (KR); Jiin JEON, Seoul (KR); Moonsub JIN, Seoul (KR); Seheon CHOI, Seoul (KR)

(73) Assignee: LG ELECTRONICS INC., Seoul (KR)

(21) Appl. No.: 16/165,508

(22) Filed: Oct. 19, 2018

(30) Foreign Application Priority Data
Jul. 20, 2018 (KR) 10-2018-0084980

(51) Int. Cl. G06K 9/00; G06F 21/32

(52) U.S. Cl. CPC G06K 9/00892; G06K 9/00087; G06F 21/32; G06K 9/00919; G06K 9/00288

(57) ABSTRACT

The present disclosure relates to an electronic device capable of performing multimodal biometric authentication, and the electronic device may include a memory configured to store information; a plurality of sensors configured to receive biometric information; a controller configured to: receive contextual information from one or more of the plurality of sensors; receive first biometric information from a first sensor of the plurality of sensors; perform a first biometric authentication comprising a generated similarity value between the received first biometric information and first biometric user information stored in the memory, wherein the first biometric authentication uses a first comparison threshold which varies based on the received contextual information; when the first biometric authentication is successful, execute the function according to the successful authentication; when the first biometric authentication is unsuccessful, perform a second biometric authentication using a second biometric information received from a second sensor of the plurality of sensors; and when a result of the first biometric authentication cannot be determined, perform a third biometric authentication using a third biometric information received from a third sensor of the plurality of sensors.

### CROSS-REFERENCE TO RELATED APPLICATIONS

Pursuant to 35 U.S.C. § 119(a), this application claims the benefit of earlier filing date and right of priority to Korean Patent Application No. 10-2018-0084980, filed on Jul. 20, 2018, the contents of which are hereby incorporated by reference herein in its entirety.

### BACKGROUND OF THE INVENTION

### 1. Field of the Invention

The present disclosure relates to an electronic device capable of performing multimodal biometric authentication.

### 2. Description of the Related Art

With the development of technology, the functions of electronic devices are diversified. For example, the functions may include data and voice communication, photographing and video shooting through a camera, voice recording, playing a music file through a speaker system, and displaying an image or video on a display unit. Some electronic devices further include an electronic game play function or perform a multimedia player function. In particular, in recent years, electronic devices may receive multicast signals that provide visual content such as broadcast, video or television programs.

As it becomes multifunctional, an electronic device may be allowed to capture still images or moving images, play music or video files, play games, receive broadcast and the like, so as to be implemented as an integrated multimedia player.

In order to support and enhance the functions of the electronic device, the improvement of structural or software elements of the terminal may be taken into consideration.

As the functions of electronic devices are diversified, the importance of user authentication for security enhancement has increased. Various methods such as a password method, a pattern method, and a biometric method may be used for user authentication.

As a method of security authentication, biometrics is a technology that performs user authentication using unique physical characteristics such as a user's fingerprint, face, voice, iris, retina, blood vessels, or the like. Such biometrics technology is less susceptible to theft or imitation, and is highly usable.

In recent years, in order to enhance security, technological advances have been made from unimodal biometrics that performs biometric authentication using a single biometric information to multimodal biometrics that performs biometric authentication using a plurality of biometric information.

In implementing such multimodal biometric authentication technology, it is required to develop various methods that utilize a plurality of biometric information. In the present disclosure, a method of performing biometric authentication using a plurality of biometric information is proposed.

### SUMMARY OF THE INVENTION

An object of the present disclosure is to provide an electronic device that performs multimodal biometric authentication in consideration of an environment at the time of performing multimodal biometric authentication.

Furthermore, another object of the present disclosure is to improve the authentication accuracy of the multimodal biometric authentication.

The present disclosure relates to an electronic device that performs biometric authentication for executing a function, the device comprising: a memory configured to store information; a plurality of sensors configured to receive biometric information; a controller configured to: receive contextual information from one or more of the plurality of sensors; receive first biometric information from a first sensor of the plurality of sensors; perform a first biometric authentication comprising a generated similarity value between the received first biometric information and first biometric user information stored in the memory, wherein the first biometric authentication uses a first comparison threshold which varies based on the received contextual information; when the first biometric authentication is successful, execute the function according to the successful authentication; when the first biometric authentication is unsuccessful, perform a second biometric authentication using a second biometric information received from a second sensor of the plurality of sensors; and when a result of the first biometric authentication cannot be determined, perform a third biometric authentication using a third biometric information received from a third sensor of the plurality of sensors.

According to another embodiment of the present disclosure, there is provided an electronic device that performs biometric authentication for executing a function, the device comprising: a memory configured to store information; a plurality of sensors configured to receive biometric information; a controller configured to: receive contextual information from one or more of the plurality of sensors; receive first biometric information from a first sensor of the plurality of sensors; perform a first biometric authentication comprising a generated similarity value between the received first biometric information and first biometric user information stored in the memory, wherein the first biometric authentication uses a first comparison threshold which varies based on the received contextual information; when the first biometric authentication is successful, execute the function according to the successful authentication; when the first biometric authentication is unsuccessful, perform a second biometric authentication using a second biometric information received from a second sensor of the plurality of sensors; and when a result of the first biometric authentication cannot be determined, select another biometric authentication from a plurality of biometric authentication and perform the selected another biometric authentication.

According to another embodiment of the present disclosure, there is provided a method of controlling an electronic device that performs biometric authentication for executing a function, the method comprising: receiving contextual information from one or more of a plurality of sensors; receiving first biometric information from a first sensor of the plurality of sensors; performing a first biometric authentication comprising a generated similarity value between the received first biometric information and first biometric user information stored in a memory of the electronic device, wherein the first biometric authentication uses a first comparison threshold which varies based on the received contextual information; when the first biometric authentication is successful, executing the function according to the successful authentication; when the first biometric authentication is unsuccessful, performing a second biometric authentication using a second biometric information received from a second sensor of the plurality of sensors; and when a result of the first biometric authentication cannot be determined, performing a third biometric authentication using a third biometric information received from a third sensor of the plurality of sensors.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram for explaining an electronic device related to the present disclosure;

FIG. 2 is a conceptual view illustrating a single biometric authentication method;

FIGS. 3A through 3D are conceptual views illustrating a multimodal biometric authentication method;

FIGS. 4A and 4B are graphs related to an error rate of a biometric authentication determination;

FIG. 5 is a conceptual view illustrating a method of performing biometric authentication in a serial manner during multimodal biometric authentication in the related art;

FIGS. 6 and 7 are conceptual views showing a method of performing multimodal biometric authentication in a serial manner during multimodal biometric authentication according to the present disclosure;

FIG. 8 is a flowchart showing a method of performing serial biometric authentication during multimodal biometric authentication according to the present disclosure;

FIGS. 9A through 15B are conceptual views showing a state in which different biometric authentication elements are selected according to a surrounding environment during multimodal biometric authentication according to the present disclosure;

FIGS. 16A and 16B are conceptual views showing a method of determining an authentication order according to a user gesture when performing multimodal biometric authentication according to the present disclosure; and

FIGS. 17A through 17C are conceptual views showing an embodiment for providing a user interface when performing multimodal biometric authentication according to the present disclosure.

### DETAILED DESCRIPTION OF THE INVENTION

Hereinafter, preferred embodiments of the present disclosure will be described in detail with reference to the accompanying drawings, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. In describing the present disclosure, moreover, the detailed description will be omitted when a specific description for publicly known technologies to which the invention pertains is judged to obscure the gist of the present disclosure. The accompanying drawings are used to help easily understand the technical idea of the present disclosure and it should be understood that the idea of the present disclosure is not limited by the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. On the contrary, in case where an element is “directly connected” or “directly linked” to another element, it should be understood that any other element is not existed therebetween.

A singular representation may include a plural representation as far as it represents a definitely different meaning from the context.

Terms “include” or “has” used herein should be understood that they are intended to indicate an existence of several components or several steps, disclosed in the specification, and it may also be understood that part of the components or steps may not be included or additional components or steps may further be included.

Portable electronic devices described herein may include cellular phones, smart phones, laptop computers, digital broadcasting terminals, personal digital assistants (PDAs), portable multimedia players (PMPs), navigators, slate PCs, tablet PCs, ultrabooks, wearable devices (for example, smart watches, smart glasses, head mounted displays (HMDs)), smart vehicles and the like.

However, it may be easily understood by those skilled in the art that the configuration according to the exemplary embodiments of this specification can also be applied to stationary terminals such as digital TV, desktop computers and the like, excluding a case of being applicable only to the electronic devices.

FIG. 1 is a block diagram for explaining an electronic device related to the present disclosure.

Referring to FIG. 1, the electronic device may include an input unit 120, a sensing unit 140, an output unit 150, an interface unit 160, a memory 170, a controller 180, a security module 181, and a power supply unit 190, and the like. The components shown in FIG. 1 are not essential for implementing an electronic device, and thus the electronic device described herein may have more or fewer components than those listed above.

In more detail, the wireless communication unit 110 of those components may typically include one or more modules which permit wireless communications between the electronic device 100 and a wireless communication system, between the electronic device 100 and another electronic device 100, or between the electronic device 100 and an external server. In addition, the wireless communication unit 110 may include one or more modules for connecting the electronic device 100 to one or more networks.

The wireless communication unit 110 may include at least one of a broadcast receiving module 111, a mobile communication module 112, a wireless Internet module 113, a short-range communication module 114, a location information module 115 and the like.

The input unit 120 may include a camera 121 for inputting an image signal, a microphone 122 or an audio input module for inputting an audio signal, or a user input unit 123 (for example, a touch key, a push key (or a mechanical key), etc.) for allowing a user to input information. Audio data or image data collected by the input unit 120 may be analyzed and processed by a user's control command.

The sensing unit 140 may include at least one sensor which senses at least one of information within the electronic device, surrounding environmental information of the electronic device, and user information. For example, the sensing unit 140 may include a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, refer to the camera 121), a microphone 122, a battery gage, an environment sensor (for example, a barometer, a hygrometer, a thermometer, a radiation detection sensor, a thermal sensor, a gas sensor, etc.), and a chemical sensor (for example, an electronic nose, a health care sensor, a biometric sensor, etc.). The biometric sensor 143 may include an iris sensor, a face recognition sensor, a PPG sensor, a voice sensor, and the like. On the other hand, the electronic device 100 disclosed herein may be configured to utilize information obtained from sensing unit 140, and in particular, information obtained from one or more sensors of the sensing unit 140, and combinations thereof.

The output unit 150 may be configured to output an audio signal, a video signal or a tactile signal. The output unit 150 may include a display unit 151, an audio output module 152, a haptic module 153, an optical output unit 154 and the like. The display unit 151 may have an inter-layered structure or an integrated structure with a touch sensor in order to facilitate a touch screen. The touch screen may provide an output interface between the electronic device100 and a user, as well as functioning as the user input unit 123 which provides an input interface between the electronic device 100 and the user.

The interface unit 160 may serve as an interface with various types of external devices connected with the electronic device 100. The interface unit 160, for example, may include wired or wireless headset ports, external power supply ports, wired or wireless data ports, memory card ports, ports for connecting a device having an identification module, audio input/output (I/O) ports, video I/O ports, earphone ports, or the like. The electronic device 100 may execute an appropriate control associated with a connected external device, in response to the external device being connected to the interface unit 160.

In addition, the memory 170 stores data that support various functions of the electronic device 100. The memory 170 is typically implemented to store data to support various functions or features of the electronic device 100. For instance, the memory 170 may be configured to store application programs executed in the electronic device 100, data or instructions for operations of the electronic device 100, and the like. At least some of those application programs may be downloaded from an external server via wireless communication. Some others of those application programs may be installed within the electronic device 100 at the time of being shipped for basic functions of the electronic device 100 (for example, receiving a call, placing a call, receiving a message, sending a message, etc.). On the other hand, the application programs may be stored in the memory 170, installed in the electronic device 100, and executed by the controller 180 to perform an operation (or a function) of the electronic device 100.

The controller 180 may typically control an overall operation of the electronic device 100 in addition to the operations associated with the application programs. The controller 180 may provide or process information or functions appropriate for a user by processing signals, data, information and the like, which are input or output by the various components depicted in FIG. 1A, or activating application programs stored in the memory 170.

Furthermore, the controller 180 may control at least part of the components illustrated in FIG. 1A, in order to drive the application programs stored in the memory 170. In addition, the controller 180 may drive the application programs by combining at least two of the components included in the electronic device 100 for operation.

The power supply unit 190 may receive external power or internal power and supply appropriate power required for operating respective elements and components included in the electronic device 100 under the control of the controller 180. The power supply unit 190 may include a battery, and the battery may be an embedded battery or a replaceable battery.

At least part of those elements and components may be combined to implement operation and control of the terminal or a control method of the electronic device according to various exemplary embodiments described herein. Furthermore, the operation and control or the control method of the portable electronic device may be implemented in the portable electronic device in such a manner of activating at least one application program stored in the memory 170.

Hereinafter, each aforementioned component will be described in more detail with reference to FIG. 1A, prior to explaining various exemplary embodiments implemented by the electronic device 100 having the configuration.

First, the wireless communication unit 110 will be described. The broadcast receiving module 111 of the wireless communication unit 110 may receive a broadcast signal and/or broadcast associated information from an external broadcast managing entity via a broadcast channel. The broadcast channel may include a satellite channel and/or a terrestrial channel. At least two broadcast receiving modules 111 may be provided in the portable electronic device 100 to simultaneously receive at least two broadcast channels or switch the broadcast channels.

The mobile communication module 112 may transmit/receive wireless signals to/from at least one of network entities, for example, a base station, an external terminal, a server, and the like, on a mobile communication network, which is constructed according to technical standards or transmission methods for mobile communications (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), etc.)

The wireless signals may include audio call signal, video (telephony) call signal, or various formats of data according to transmission/reception of text/multimedia messages.

The wireless Internet module 113 means a module for supporting wireless Internet access. The wireless Internet module 113 may be built-in or externally installed to the electronic device 100. The wireless Internet module 113 may transmit and/or receive wireless signals via communication networks according to wireless Internet technologies.

Examples of such wireless Internet access may include Wireless LAN (WLAN), Wireless-Fidelity (Wi-Fi), Wireless Fidelity Direct (Wi-Fi Direct), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), LTE (Long Term Evolution), LTE-A (Long Term Evolution-Advanced), and the like. The wireless Internet module 113 may transmit/receive data according to at least one wireless Internet technology within a range including even Internet technologies which are not aforementioned.

From the perspective that the wireless Internet accesses according to Wibro, HSDPA, GSM, CDMA, WCDMA, LTE, LTE-A and the like are executed via a mobile communication network, the wireless Internet module 113 which performs the wireless Internet access via the mobile communication network may be understood as a type of the mobile communication module 112.

The short-range communication module 114 denotes a module for short-range communications. Suitable technologies for implementing the short-range communications may include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, and the like. The short-range communication module 114 may support wireless communications between the electronic device 100 and a wireless communication system, between the electronic device 100 and another electronic device 100, or between the electronic device and a network where another electronic device (or an external server) is located, via wireless personal area networks. The short-range communication module 114 denotes a module for short-range communications.

In some embodiments, another electronic device (which may be configured similarly to electronic device 100) may be a wearable device, for example, a smart watch, a smart glass or a head mounted display (HMD), which is able to exchange data with the electronic device 100 (or otherwise cooperate with the electronic device 100). The short-range communication module 114 may sense (recognize) a wearable device, which is able to communicate with the electronic device 100, near the electronic device 100. In addition, when the sensed wearable device is a device which is authenticated to communicate with the electronic device 100 according to the present disclosure, the controller 180 may transmit at least part of data processed in the electronic device 100 to the wearable device via the short-range communication module 114. Hence, a user of the wearable device may use the data processed in the electronic device 100 on the wearable device. For example, when a call is received in the electronic device 100, the user may answer the call using the wearable device. Also, when a message is received in the electronic device 100, the user can check the received message using the wearable device.

The location information module 115 is generally configured to detect, calculate, derive or otherwise identify a position of the electronic device. As an example, the location information module 115 includes a Global Position System (GPS) module, a WiFi module, or both. For example, when the electronic device uses the GPS module, a position of the electronic device may be acquired using a signal sent from a GPS satellite. As another example, when the electronic device uses the Wi-Fi module, a position of the electronic device may be acquired based on information associated with a wireless access point (AP) which transmits or receives a wireless signal to or from the Wi-Fi module. According to the need, the location information module 115 may perform any function of the other modules of the wireless communication unit 110 to obtain data on the location of the electronic device. As a module used to acquire the location (or current location) of the electronic device, the location information module 115 may not be necessarily limited to a module for directly calculating or acquiring the location of the electronic device.

The input unit 120 may be configured to provide an audio or video signal (or information) input to the electronic device or information input by a user to the electronic device. For the input of the audio information, the electronic device 100 may include one or a plurality of cameras 121. The camera 121 processes a image frame, such as still picture or video, acquired by an image sensor in a video phone call or image capturing mode. The processed image frames may be displayed on the display unit 151. On the other hand, the plurality of cameras 121 disposed in the electronic device 100 may be arranged in a matrix configuration. By use of the cameras 121 having the matrix configuration, a plurality of image information having various angles or focal points may be input into the electronic device 100. As another example, the cameras 121 may be located in a stereoscopic arrangement to acquire left and right images for implementing a stereoscopic image.

The microphone 122 may process an external audio signal into electric audio data. The processed audio data may be utilized in various manners according to a function being executed in the electronic device 100 (or an application program being executed). On the other hand, the microphone 122 may include assorted noise removing algorithms to remove noise generated in the course of receiving the external audio signal.

The user input unit 123 may receive information input by a user. When information is input through the user input unit 123, the controller 180 may control an operation of the electronic device 100 to correspond to the input information. The user input unit 123 may include a mechanical input element (or a mechanical key, for example, a button, a dome switch, a jog wheel, a jog switch or the like located on a front/rear surface or a side surface of the electronic device 100), and a touch-sensitive input element. As one example, the touch-sensitive input element may be a virtual key, a soft key or a visual key, which is displayed on a touch screen through software processing, or a touch key which is disposed on a portion except for the touch screen. On the other hand, the virtual key or the visual key may be displayable on the touch screen in various shapes, for example, graphic, text, icon, video or a combination thereof.

On the other hand, the sensing unit 140 may sense at least one of internal information of the electronic device, surrounding environment information of the electronic device and user information, and generate a sensing signal corresponding thereto. The controller 180 may control an operation of the electronic device 100 or execute data processing, a function or an operation associated with an application program installed in the electronic device 100 based on the sensing signal. Hereinafter, description will be given in more detail of representative sensors of various sensors which may be included in the sensing unit 140.

First, a proximity sensor 141 refers to a sensor to sense presence or absence of an object approaching to a surface to be sensed, or an object disposed near a surface to be sensed, by using an electromagnetic field or infrared rays without a mechanical contact. The proximity sensor 141 may be arranged at an inner region of the electronic device covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 may sense proximity of a pointer to the touch screen by changes of an electromagnetic field, which is responsive to an approach of an object with conductivity. In this case, the touch screen (touch sensor) may also be categorized as a proximity sensor.

On the other hand, for the sake of brief explanation, a behavior in which the pointer is positioned to be proximate onto the touch screen without contact will be referred to as “proximity touch,” whereas a behavior in which the pointer substantially comes into contact with the touch screen will be referred to as “contact touch.” For the position corresponding to the proximity touch of the pointer on the touch screen, such position will correspond to a position where the pointer faces perpendicular to the touch screen upon the proximity touch of the pointer. The proximity sensor 141 may sense proximity touch, and proximity touch patterns (e.g., distance, direction, speed, time, position, moving state, etc.). On the other hand, the controller 180 may process data (or information) corresponding to the proximity touches and the proximity touch patterns sensed by the proximity sensor 141, and output visual information corresponding to the process data on the touch screen. In addition, the controller 180 may control the electronic device 100 to execute different operations or process different data (or information) according to whether a touch with respect to the same point on the touch screen is either a proximity touch or a contact touch.

A touch sensor may sense a touch (or touch input) applied onto the touch screen (or the display unit 151) using at least one of various types of touch methods, such as a resistive type, a capacitive type, an infrared type, a magnetic field type, and the like.

As one example, the touch sensor may be configured to convert changes of pressure applied to a specific part of the display unit 151 or a capacitance occurring from a specific part of the display unit 151, into electric input signals. Also, the touch sensor may be configured to sense not only a touched position and a touched area, but also touch pressure. Here, the touch object body may be a finger, a touch pen or stylus pen, a pointer, or the like as an object through which a touch is applied to the touch sensor.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180 or the controller 180 itself.

On the other hand, the controller 180 may execute a different control or the same control according to a type of an object which touches the touch screen (or a touch key provided in addition to the touch screen). Whether to execute the different control or the same control according to the object which gives a touch input may be decided based on a current operating state of the electronic device 100 or a currently executed application program.

Meanwhile, the touch sensor and the proximity sensor may be executed individually or in combination, to sense various types of touches, such as a short (or tap) touch, a long touch, a multi-touch, a drag touch, a flick touch, a pinch-in touch, a pinch-out touch, a swype touch, a hovering touch, and the like.

An ultrasonic sensor may be configured to recognize position information relating to a sensing object by using ultrasonic waves. On the other hands, the controller 180 may calculate a position of a wave generation source based on information sensed by an illumination sensor and a plurality of ultrasonic sensors. Since light is much faster than ultrasonic waves, a time for which the light reaches the optical sensor may be much shorter than a time for which the ultrasonic wave reaches the ultrasonic sensor. The position of the wave generation source may be calculated using the fact. In more detail, the position of the wave generation source may be calculated by using a time difference from the time that the ultrasonic wave reaches based on the light as a reference signal.

The camera 121 constructing the input unit 120 may be a type of camera sensor. The camera sensor may include at least one of a photo sensor (or image sensor) and a laser sensor.

Implementing the camera 121 with a laser sensor may allow detection of a touch of a physical object with respect to a 3D stereoscopic image. The photo sensor may be laminated on the display device. The photo sensor may be configured to scan a movement of the sensing object in proximity to the touch screen. In more detail, the photo sensor may include photo diodes and transistors at rows and columns to scan content placed on the photo sensor by using an electrical signal which changes according to the quantity of applied light. Namely, the photo sensor may calculate the coordinates of the sensing object according to variation of light to thus obtain position information of the sensing object.

The display unit 151 may display (output) information processed in the electronic device 100. For example, the display unit 151 may display execution screen information of an application program driven in the electronic device 100 or user interface (UI) and graphic user interface (GUI) information in response to the execution screen information.

Furthermore, the display unit 151 may also be implemented as a stereoscopic display unit for displaying stereoscopic images.

The stereoscopic display unit may employ a stereoscopic display scheme such as stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. Also, the audio output module 152 may also provide audible output signals associated with a particular function (e.g., a call signal reception sound, a message reception sound, etc.) carried out by the electronic device 100. The audio output module 152 may include a receiver, a speaker, a buzzer or the like.

A haptic module 153 may generate various tactile effects the that user may feel. A typical example of the tactile effect generated by the haptic module 153 may be vibration. Strength, pattern and the like of the vibration generated by the haptic module 153 may be controllable by a user selection or setting of the controller. For example, the haptic module 153 may output different vibrations in a combining manner or a sequential manner.

Besides vibration, the haptic module 153 may generate various other tactile effects, including an effect by stimulation such as a pin arrangement vertically moving with respect to a contact skin, a spray force or suction force of air through a jet orifice or a suction opening, a touch on the skin, a contact of an electrode, electrostatic force, etc., an effect by reproducing the sense of cold and warmth using an element that can absorb or generate heat, and the like.

The haptic module 153 may be configured to transmit tactile effects through a user's direct contact, or a user's muscular sense using a finger or a hand. The haptic module 153 may be implemented in two or more in number according to the configuration of the electronic device 100.

An optical output module 154 may output a signal for indicating an event generation using the light of a light source of the electronic device 100. Examples of events generated in the electronic device 100 may include a message reception, a call signal reception, a missed call, an alarm, a schedule notice, an email reception, an information reception through an application, and the like.

A signal output by the optical output module 154 may be implemented in such a manner that the electronic device emits monochromatic light or light with a plurality of colors. The signal output may be terminated as the electronic device senses a user's event checking.

The interface unit 160 serves as an interface for external devices to be connected with the electronic device 100. For example, the interface unit 160 can receive data transmitted from an external device, receive power to transfer to elements and components within the electronic device 100, or transmit internal data of the electronic device 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the electronic device 100 and may include a user identity module (UIM), a subscriber identity module (SIM), a universal subscriber identity module (USIM), and the like. In addition, the device having the identification module (also referred to herein as an “identification device”) may take the form of a smart card. Accordingly, the identifying device may be connected with the electronic device 100 via the interface unit 160.

Also, the interface unit 160 may serve as a path for power to be supplied from an external cradle to the electronic device 100 when the electronic device 100 is connected to the external cradle or as a path for transferring various command signals inputted from the cradle by a user to the electronic device 100. Such various command signals or power inputted from the cradle may operate as signals for recognizing that the electronic device 100 has accurately been mounted to the cradle.

The memory 170 can store programs to support operations of the controller 180 and store input/output data (for example, phonebook, messages, still images, videos, etc.). The memory 170 may store data associated with various patterns of vibrations and audio which are output in response to touch inputs on the touch screen.

The memory 170 may include at least one type of storage medium including a Flash memory, a hard disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the electronic device 100 may operate a web storage which performs the storage function of the memory 170 on the Internet.

As aforementioned, the controller 180 may typically control the general operations of the electronic device 100. For example, the controller 180 may set or release a lock state for restricting a user from inputting a control command with respect to applications when a state of the electronic device meets a preset condition.

Furthermore, the controller 180 may also perform controlling and processing associated with voice calls, data communications, video calls, and the like, or perform pattern recognition processing to recognize a handwriting input or a picture drawing input performed on the touch screen as characters or images, respectively. In addition, the controller 180 may control one or combination of those components in order to implement various exemplary embodiment disclosed herein on the electronic device 100.

The security module 181 controls an operation related security among the operations of the electronic device. For example, when a biometric authentication function is executed, the security module 181 may perform control related to biometric authentication. For example, the security module 181 may perform biometric authentication using an artificial neural network algorithm or an SVM algorithm, which is an algorithm for biometric authentication. In addition, the security module 181 may perform an algorithmic operation, such as Fuzzy logic, Dempster-Shafer theory, SVM, relevance vector machine (RVM) mean rule, Monte Carlo approach, phase stretch transform (PST), neural network, principal component analysis, Fisherfaces, Wavelet and Elastic Matching, or the like, which are algorithms for biometric authentication.

The security module 181 may communicate with the controller 180 to transmit and receive data, thereby controlling an overall operation of the electronic device. For example, the controller 180 may receive user authentication result data from the security module 181 and control an operation of the electronic device based on the received data. In addition, the security module 181 may receive a control command for performing biometric authentication from the controller 180, thereby performing biometric authentication.

On the other hand, in FIG. 1, the security module 181 and the controller 180 are illustrated as being separate components, but the present disclosure is not limited thereto, and the security module 181 may be configured as one component of the controller 180.

The power supply unit 190 may receive external power or internal power and supply appropriate power required for operating respective elements and components included in the electronic device 100 under the control of the controller 180. The power supply unit 190 may include a battery, which is typically rechargeable or be detachably coupled to the terminal body for charging.

Furthermore, the power supply unit 190 may include a connection port. The connection port may be configured as one example of the interface unit 160 to which an external (re)charger for supplying power to recharge the battery is electrically connected.

As another example, the power supply unit 190 may be configured to recharge the battery in a wireless manner without use of the connection port. Here, the power supply unit 190 may receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable or its similar medium using, for example, software, hardware, or any combination thereof.

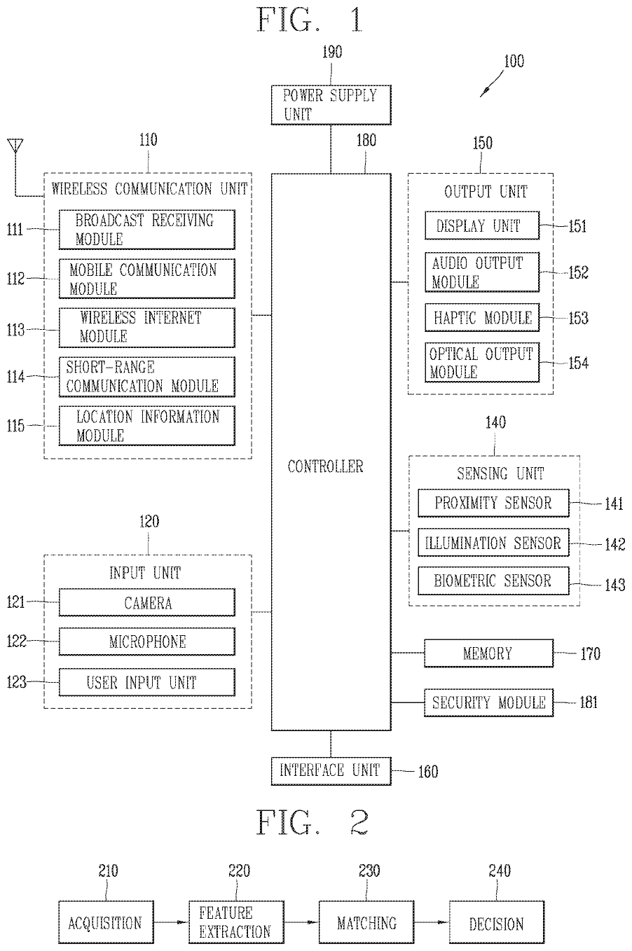

Hereinafter, a method of performing biometric authentication in the electronic device described in FIG. 1 will be described in detail. FIG. 2 is a conceptual view illustrating a single biometric authentication method.

Referring to FIG. 2, single biometric authentication may include the steps of acquisition 210, feature extraction 220, matching 230 and decision 240.

In the acquisition step 210, biometric information may be acquired through a biometric sensor. The biometric information may include a user's own biometric information such as fingerprint, face, voice, vein, iris, and the like.

In the feature extraction step 220, the features of the biometric information may be extracted. The feature is information capable of recognizing the unique characteristic of each person. For example, in the case of a fingerprint, a point representing a specific shape of the fingerprint may be set as a feature. These features are set differently for each biometric authentication method.

In the matching step 230, a matching score between previously registered user information and sensed biometric information may be calculated. The previously registered user information is biometric information stored in advance by a user prior to performing biometric authentication. The user store fingerprint information, face information, voice information, vein information, iris information, and the like in advance in the memory 170 in a templet shape.

The matching score indicates a similarity between the previously registered user information and the biometric information. Various algorithms previously known in the related art may be used as an algorithm for calculating matching scores.

In the decision step 240, user authentication may be carried out using the matching score and the decision function. The decision function is a function that determines whether a user who enters biometric information is a genuine user or an imposter user. The decision function may be set to a specific threshold value, or may be set to a multidimensional function.

The decision function may be set to an initial setting value (default) by a manufacturer of a biometric authentication function. Furthermore, the decision function may change the initial setting value using the user's biometric information sensed through the biometric sensor. Accordingly, the electronic device may improve the speed and accuracy of biometric recognition as a lot of biometric operations are carried out.

In addition, the decision function may be generated differently according to information used to generate the decision function. Moreover, the differently generated decision function may be stored in the memory 170 in a plurality of ways. For example, the decision function may be generated with only a matching score, or may be generated using a matching score and a spoofing score. In this case, both of the decision functions may be stored in the memory 170, and biometric authentication may be carried out using any one of the decision functions as needed.

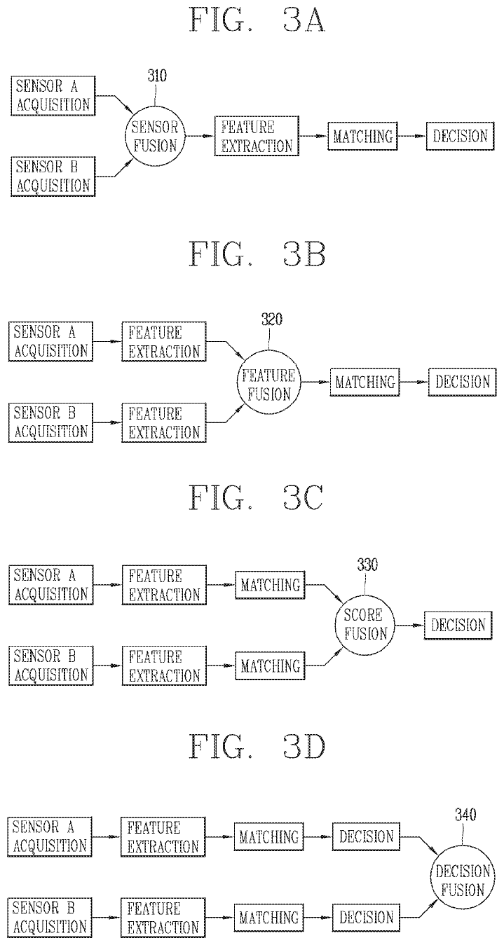

A single biometric authentication method has been described above. Hereinafter, a multimodal biometric authentication method will be described. FIGS. 3A through 3D are conceptual views illustrating a multimodal biometric authentication method.

Multimodal biometric authentication may be divided into four types according to the time of fusioning a plurality of biometric information. Here, fusion refers to an operation of combining a plurality of information according to a preset algorithm to generate one information, and may be used in terms of coupling, combination, fusion, and matching.

FIG. 3A has shown a sensor fusion method 310. The sensor fusion method 310 is a method of combining a plurality of biometric information acquired from different sensors in the step of acquiring biometric information. Specifically, the sensor fusion method is a method of fusioning biometric information sensed by different biometric sensors and extracting features from the fusioned information.

FIG. 3B has shown a feature fusion method 320. The feature fusion method 320 is a method of respectively extracting feature from a plurality of biometric information acquired from different biometric sensors in the step of extracting the features of biometric information, and combining the respectively extracted features.

FIG. 3C has shown a score fusion method 330. The score fusion method 330 is a method of combining matching scores calculated for each of the plurality of biometric information in the step of matching biometric information.

FIG. 3D has shown a decision fusion method 340. The decision fusion method 340 is a method of combining decision results calculated for each of the plurality of biometric information in the step of determining biometric information.

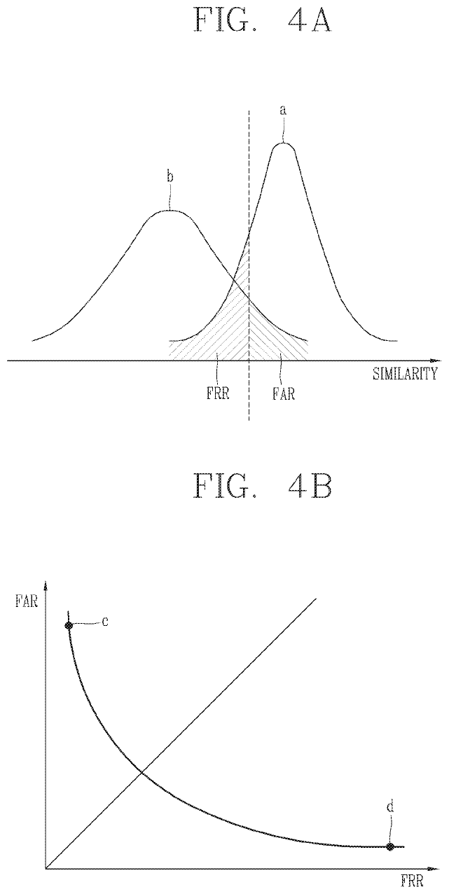

Various methods of multimodal biometric authentication have been described above. Hereinafter, an error rate of biometrics related to a decision function will be described in the case of user authentication through biometric authentication. FIGS. 4A and 4B are graphs related to an error rate of a biometric authentication determination.

Graph “a” in FIG. 4A is a graph showing a similarity distribution between the biometric information of a genuine user and the previously registered user information at the time of biometric authentication, and graph “b” in FIG. 4A is a graph showing a similarity distribution between the biometric information of an imposter user and the previously registered user information.

The graphs “a” and “b” have overlapping portions, and the electronic device 100 determines a user as a genuine user when having a similarity higher than a threshold value indicated by dotted line aa′, and determines the user as an imposter user when having a similarity lower than the threshold value. Here, the threshold value may be a value determined by a provider providing a biometric authentication function, and denotes the above-described decision function.

On the other hand, a false rejection rate (FRR) illustrated in FIG. 4A indicates a rate determined to be an imposter user although the user is a genuine user. Since the higher the FRR is, the higher the threshold value, and thus a probability that the user who has entered biometric information is determined as a genuine user is decreased, the security of the biometric authentication may be enhanced. Since the lower the FRR is, the lower the threshold value, and thus a probability that the user who has entered biometric information is determined as a genuine user is increased, the security of the biometric authentication may be reduced.

A false acceptance rate (FAR) indicates an error rate determined to be a genuine user although the user is a genuine user. FAR is a concept contrary to FRR, and since the higher the FAR is, the lower the threshold value, and thus a probability that the user who has entered biometric information is determined as a genuine user is increased, the security of the biometric authentication may be reduced.

FIG. 4B is a graph showing a relationship between a FRR and a FAR. The FRR and the FAR may be inversely proportional to each other. A threshold value corresponding to region d having a high FRR and a low FAR may be used for applications requiring high security although having a low authentication speed. For example, a threshold value for this area may be set in a billing application, a banking application, which strictly determines a genuine user. On the contrary, a threshold value corresponding region c having a low FRR and a high FAR may be used for applications requiring low security although having a high authentication speed. For example, a threshold value corresponding to this region may be used for an unlock function or the like. The threshold value (i.e., decision function) of the biometric authentication function may be determined in consideration of a security level of functions to be executed through biometric authentication. Parameters related to an error at the time of biometric authentication have been described above.

[Description of Algorithm in Score Fusion Method]

Hereinafter, an algorithm that can be used in a score fusion method among multimodal biometric authentication methods will be described.

In the score fusion method, a variety of artificial intelligence algorithms that combine match scores may be used. A combination-based score fusion algorithm, a classifier-based score fusion algorithm, and a density-based score fusion algorithm may be used in an algorithm that can be used in the score fusion method.

The combination-based score fusion algorithm may include statistical rules, dynamic weighting, triangular norms, and the like. The classifier-based score fusion algorithm may include support vector machine (SVM), AdaBoost (RS-ADA), and Dampster-Shafer (DS). The density-based score fusion algorithm may include a likelihood feature (LF).

In addition, various algorithms and the like known in a secure fusion method may be used in the present disclosure, and the detailed description thereof will be omitted in order not to depart from the spirit of the present disclosure.

Hereinafter, biometric authentication in a serial manner in which two or more different biometric authentication methods are sequentially performed to perform biometric authentication will be described with reference to the drawings.

FIG. 5 is a conceptual view illustrating a method of performing biometric authentication in a serial manner during multimodal biometric authentication in the related art.

Biometric authentication may be classified according to biometric information. For example, the biometric authentication may include face authentication, fingerprint authentication, voice authentication, iris authentication, vein authentication, and the like, and a user may perform biometric authentication using a variety of human body information capable of exhibiting a person's unique characteristics.

The multimodal biometric authentication is a method of performing biometric authentication using different biometric information.

The method of multimodal biometric authentication may include serial biometric authentication and parallel biometric authentication according to the time of acquisition of biometric information. Specifically, the serial method is a method of sequentially acquiring a plurality of biometric information, and the parallel method is a method of acquiring a plurality of biometric information at the same time and fusing the acquired biometric information at the same time to perform biometric authentication.

The serial method is advantageous in that a period of time required for biometric authentication is short because one method of biometric authentication is carried out at a time, and has good usability. However, the serial method has a lower accuracy compared to the parallel method.

According to the present disclosure, a method of performing biometric authentication using a serial method will be described. Hereinafter, a serial method in the related art will be described in more detail with reference to the drawings.

Referring to FIG. 5, serial biometric authentication acquires one biometric information to perform biometric authentication (primary user authentication, 510). For a result of performing the primary user authentication 510, there are an authentication success 520 in which previously registered user information and acquired biometric information match each other or an authentication failure 530 in which previously registered user information and acquired biometric information do not match each other. In the case of the authentication failure 530, serial biometric authentication acquires another biometric information to perform additional authentication (secondary user authentication, 540).

In other words, the serial biometric authentication sequentially recognizes and authenticates different biometric information according to a preset order. Such a serial biometric authentication may also be referred to as sequential authentication, cascaded authentication, or multi-stage fusion authentication.

For the serial biometric authentication, optimization of thresholds based on linear model, a symmetric rejection method, a marcialis's method, a SPRT-based method, serial fusion based semi-supervised learning techniques, a quality-based adaptive context switching algorithm, or the like, may be used.

On the other hand, for the serial biometric authentication in the related art, the order of biometric authentications is set in advance, and user authentication is sequentially carried out according to the set order. However, in the case of biometric authentication, since the user's biometric information is sensed through biometric sensors, the biometric information that can be acquired or the sensing accuracy of biometric authentication may vary according to a surrounding environment or the user's situation at the time of biometric authentication. However, since multimodal biometric authentication is carried out without taking this situation into consideration in the related art, there has been a problem that the user convenience is lowered and the accuracy of biometric authentication is lowered.

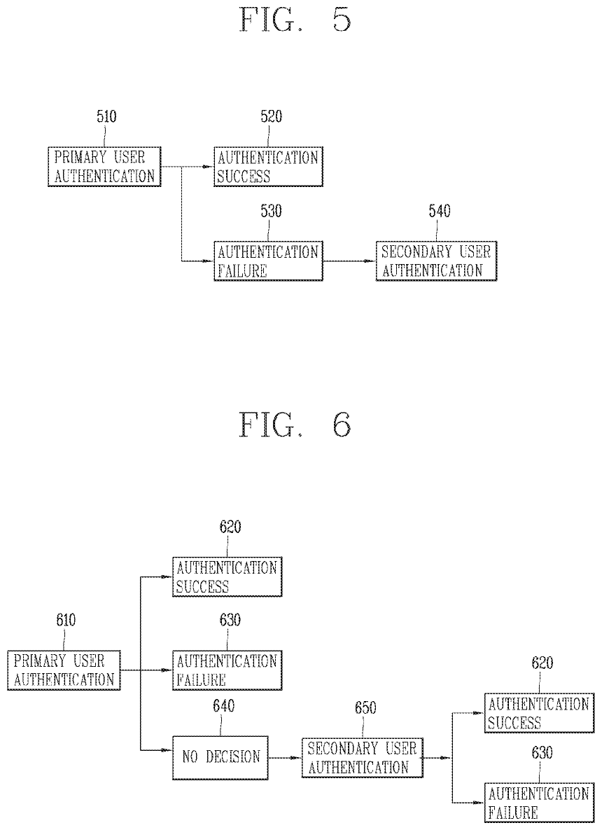

Hereinafter, a serial biometric authentication method for solving such a problem will be described. FIGS. 6 and 7 are conceptual views showing a method of performing multimodal biometric authentication in a serial manner according to the present disclosure.

Referring to FIG. 6, the serial biometric authentication according to the present disclosure is divided into a primary user authentication 610 and a secondary user authentication 650. The primary user authentication 610 and the secondary user authentication 650 are biometric authentication methods using different biometric information. For example, the primary user authentication 610 may be fingerprint recognition, and the secondary user authentication 650 may be face recognition.

The execution result of the primary user authentication 610 is divided into an authentication success 620, an authentication failure 630, and no decision 640.

Specifically, when a degree of similarity between previously registered user information and acquired biometric information is greater than (or equal to) a first reference value (P1 in FIG. 7), the security module 181, which processes biometric information, determines that it is an authentication success 620. The first reference value (P1) is a value at which the FAR becomes zero.

Furthermore, when a degree of similarity between previously registered user information and acquired biometric information is less than (or equal to) a second reference value (P2 in FIG. 7), the security module 181 determines that it is an authentication failure 630. The second reference value (P2) is a value at which the FRR becomes zero. The security module 181 may perform an authentication initialization operation in the case of the authentication failure 630. The authentication initialization operation denotes an operation of switching to a standby state capable of performing the primary user authentication again.

Furthermore, when a degree of similarity between previously registered user information and acquired biometric information is greater than or equal to a second reference value (P2) but less than or equal to a first reference value (P1), the security module 181 determines that it is no decision 640. In this case, the security module 181 performs the secondary user authentication 650. In other words, in the multimodal biometric authentication according to the present disclosure, the secondary user authentication 650 may be carried out only when it is no decision.

In the multimodal biometric authentication according to the present disclosure, the secondary user authentication 650 may perform biometric authentication using biometric information acquired from the primary user authentication and newly acquired biometric information. At this time, the newly acquired biometric information is biometric information different from the biometric information acquired from the primary user authentication. For example, in the case where fingerprint recognition information is acquired from the primary user authentication, face recognition information may be acquired from the secondary user authentication.

The secondary user authentication 650 may perform biometric authentication using any one of fusion methods described above with reference to FIGS. 3A through 3D. For example, the secondary user authentication may perform user authentication by combining a comparison result acquired by comparing the previously registered user information with first biometric information, which is carried out at the time of the primary user authentication, with a comparison result acquired by comparing secondary biometric information with the previously registered user information by a preset algorithm. Accordingly, the secondary user authentication 650 may have a higher accuracy than the primary user authentication 610.

The security module 181 determines that the execution result of the secondary user authentication 650 is either one of an authentication success or an authentication failure. Then, the secondary user authentication 650 may end the user authentication.

On the other hand, the security module 181 may perform an authentication initialization operation when the execution of the secondary user authentication 650 is completed. Accordingly, the user may retry the primary user authentication again.

In the above, biometric authentication in a serial manner according to the present disclosure has been described. Hereinafter, a method of performing biometric authentication in consideration of situation information during serial multimodal biometric authentication according to the present disclosure will be described in more detail.

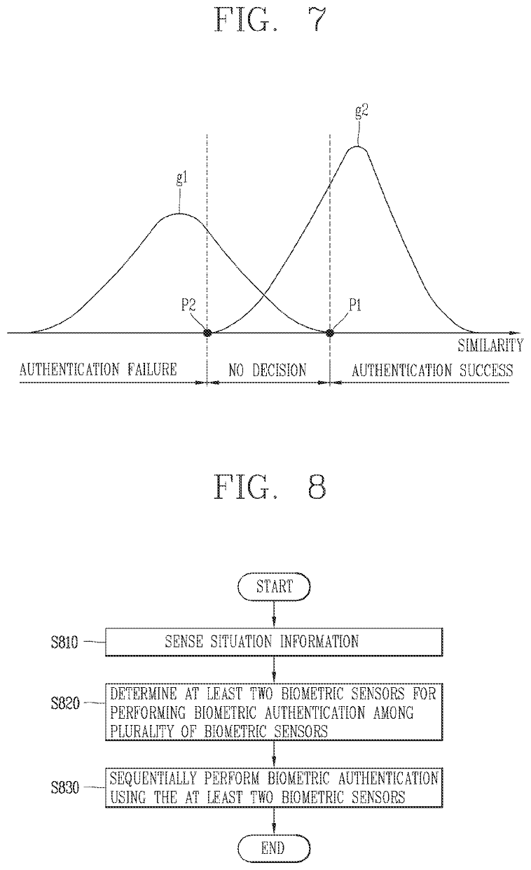

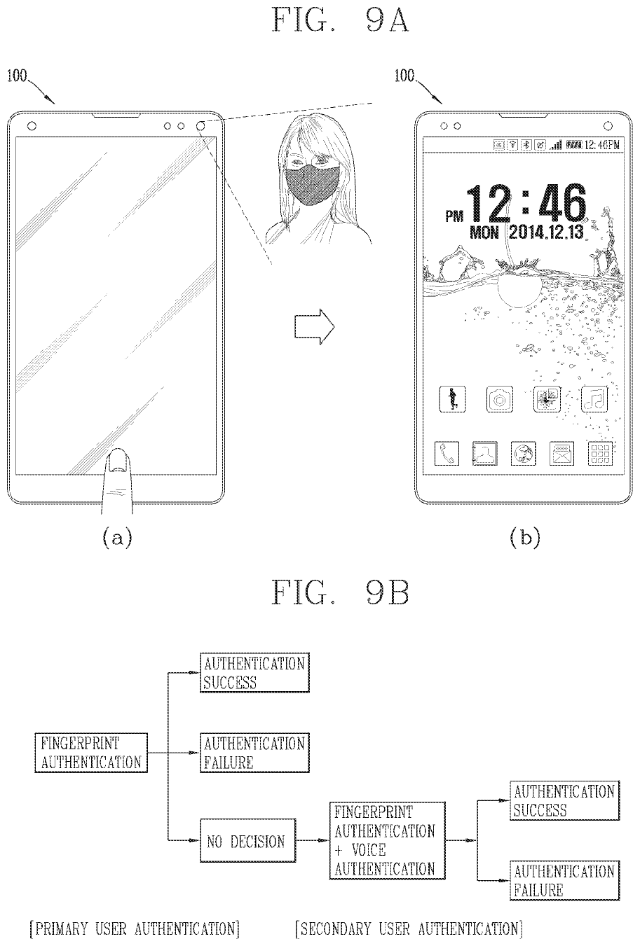

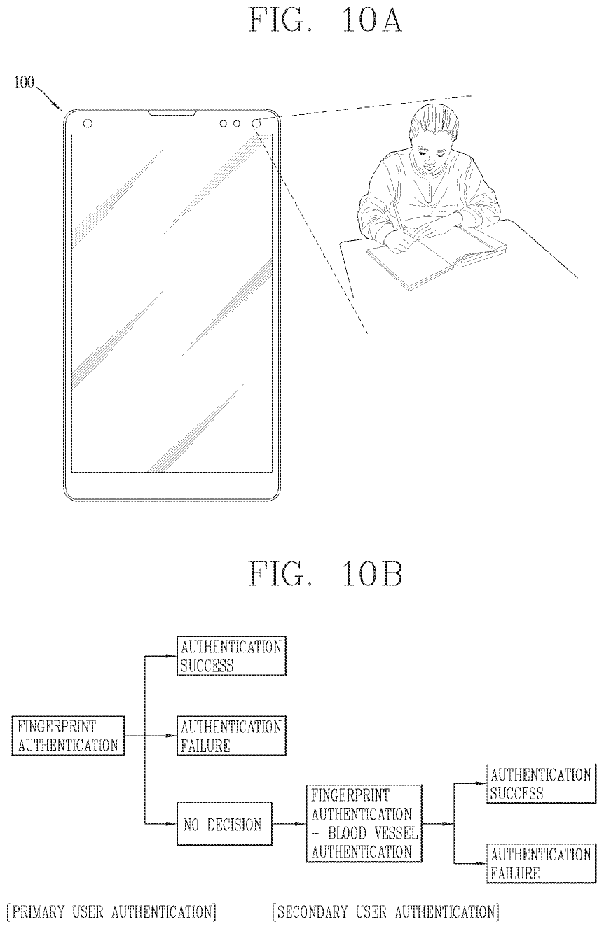

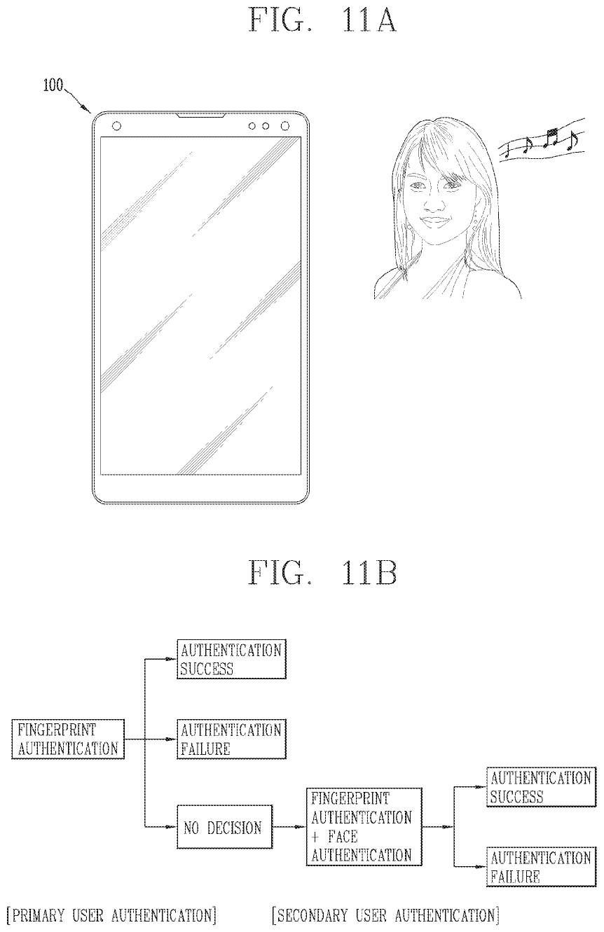

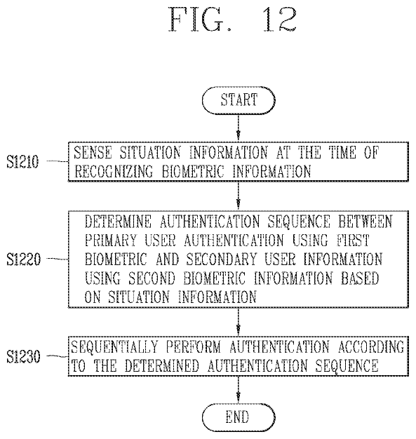

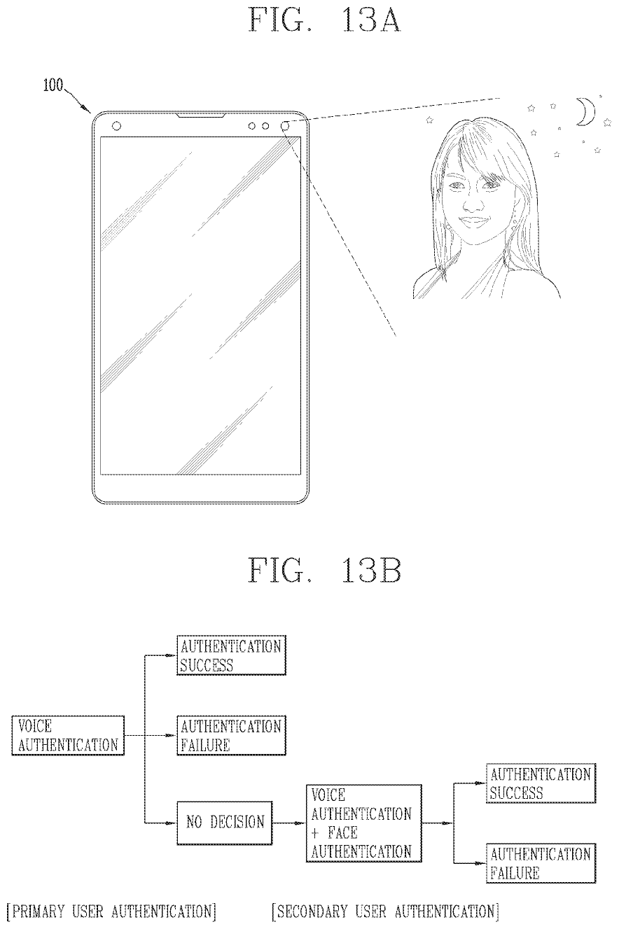

FIG. 8 is a flowchart showing a method of selecting an authentication element of serial multimodal biometric authentication in consideration of situation information. FIGS. 9A and 11B are conceptual views for explaining the control method of FIG. 8.

The electronic device 100 according to the present disclosure may determine at least two biometric sensors for performing biometric recognition in consideration of the situation of a user among a plurality of biometric sensors, and perform multimodal biometric authentication using the determined biometric sensors. Hereinafter, the control method will be described in more detail with reference to the drawings.

First, referring to FIG. 8, the security module 181 of the electronic device 100 according to the present disclosure may sense situation information (S810).

The security module 181 may execute a biometric authentication function in real time or when an execution command for a function requiring biometric authentication is issued. For example, the security module 181 may perform a biometric authentication function in the background in real time or at preset periodic intervals. For another example, when it is sensed that the user uses the electronic device 100, the security module 181 may perform a biometric authentication function in real time or at preset periodic intervals. For still another example, the security module 181 may execute a biometric authentication function based on the issuance of a control command for executing biometric authentication.

When the biometric authentication function is executed, the security module 181 may activate at least two biometric sensors so that the at least two of a plurality of biometric sensors provided in the electronic device 100 can sense biometric information. Alternatively, the security module 181 may activate all of the plurality of biometric sensors.

The security module 181 may collect situation information indicating a situation related to the biometric authentication of the electronic device 100 when a biometric authentication function is executed or biometric authentication information is sensed through at least one biometric sensor. The security module 181 may collect situation information using environment sensors provided in the electronic device, information stored in the memory, and the like.

The situation information is the situation information at the time of sensing biometric information sensed by the biometric sensor. The situation information may include environmental information related to the surrounding environment of the electronic device such as ambient illuminance, ambient noise, ambient temperature, and the like, user information associated with a user performing biometric authentication, characteristic information indicating unique characteristics of biometric information, and an input sequence of biometric information.

The security module 181 may determine at least two biometric sensors for performing biometric authentication among the plurality of biometric sensors based on the situation information and the characteristic information of biometric information (S820).

The security module 181 may perform multimodal biometric authentication using different biometric sensors according to the situation information and the characteristic information of biometric information. Here, the characteristic information of biometric information is information indicating the unique characteristics of the biometric information. The unique characteristics may include quality information of the biometric information, characteristics related to a method of collecting the biometric information, and the like. For example, in the case of face recognition information, the quality information is a resolution of the face recognition information, and the characteristic information related to a method of collecting the biometric information may include a characteristic of generating a shutter sound, and a characteristic that should be captured at a predetermined level or higher, and the like when image capturing is carried out to acquire a face image.

For example, referring to FIG. 9A, the security module 181 may sense (or acquire, or collect) a user's face image through the camera 121. The security module 181 may analyze the user's face image, and determine the possibility of performing face authentication using the analysis result. As shown in FIG. 9A, the security module 181 may determine that face authentication is impossible when a part (nose or mouth) of a face cannot be detected from the user's face image. In this case, the security module 181 may determine a fingerprint recognition sensor for fingerprint authentication, and a voice sensor for voice authentication, excluding the face authentication, as biometric sensors for performing biometric authentication.

For another example, referring to FIG. 10A, the security module 181 may sense ambient noise through the voice sensor. Furthermore, when ambient noise is lower than a first level, the security module 181 may determine that voice authentication through the voice sensor and face authentication through the image sensor are impossible. Accordingly, the security module 181 may determine the fingerprint sensor for fingerprint authentication and the blood vessel sensor for blood vessel authentication as the biometric authentication sensors.

For still another example, referring to FIG. 11A, the security module 181 may sense ambient noise through the voice sensor. Furthermore, the security module 181 may determine that the voice authentication through the voice sensor is impossible when ambient noise is above a second level. Accordingly, the security module 181 may determine the fingerprint sensor for fingerprint authentication and the face sensor for face authentication as the biometric authentication sensors.

For yet still another example, although not shown, the security module 181 may sense ambient illumination through the illumination sensor. The security module 181 may determine that face authentication through the image sensor is impossible when ambient illuminance is lower than a reference illuminance. Accordingly, the security module 181 may determine the voice sensor for voice authentication and the fingerprint sensor for fingerprint authentication as sensors for biometric authentication.

Through this, the user may perform biometric authentication with a biometric authentication method most suitable for a current situation, thereby enhancing the convenience of biometric authentication.

The security module 181 may sequentially perform biometric authentication using the determined at least two biometric sensors.

The security module 181 may set the authentication sequence of biometric authentication based on the characteristic information of biometric information and the situation information. The authentication sequence indicates a sequence in which the authentication is carried out.

For example, as shown in FIG. 9B, the security module 181 may determine the fingerprint sensor and the voice sensor as sensors for biometric authentication. When it is determined that the user covers his or her mouth with a mask through the image information of the user, the security module 181 may set the authentication sequence to perform fingerprint authentication prior to voice authentication. Accordingly, fingerprint authentication is set for the primary user authentication, and multimodal biometric authentication fused with the fingerprint authentication and the voice authentication is set for the secondary user authentication.

For another example, as shown in FIG. 10B, the security module 181 may determine the fingerprint sensor and the blood vessel sensor as sensors for performing biometric authentication when ambient noise is below a first reference level. Then, the security module 181 may compare the accuracy of fingerprint authentication with the accuracy of blood vessel authentication, perform a fingerprint authentication method with higher accuracy first, and perform multimodal biometric authentication fused with blood vessel authentication and fingerprint authentication with lower accuracy. In other words, fingerprint authentication is set for the primary user authentication, and multimodal biometric authentication fused with fingerprint authentication and blood vessel authentication is set for the secondary user authentication.

For another example, as shown in FIG. 11B, the security module 181 may determine the fingerprint sensor and the face sensor as sensors for performing biometric authentication when ambient noise is above a second reference level. Then, the security module 181 may perform fingerprint authentication first based on the accuracy information of the fingerprint sensor and the face sensor and the ambient illuminance, and perform multimodal biometric authentication fused with the fingerprint authentication and the face authentication later.

Meanwhile, the security module 181 may sequentially perform biometric authentication according to a preset priority among the sensors. In this case, priorities among the plurality of biometric sensors are set in advance. When at least two biometric sensors for performing biometric authentication among the plurality of biometric sensors are determined, the security module 181 determines an authentication sequence according to the priorities of the determined at least two biometric sensors.

In the above, a method of determining a biometric authentication element for performing serial biometric authentication in consideration of the situation information and the characteristic information of biometric information has been described.

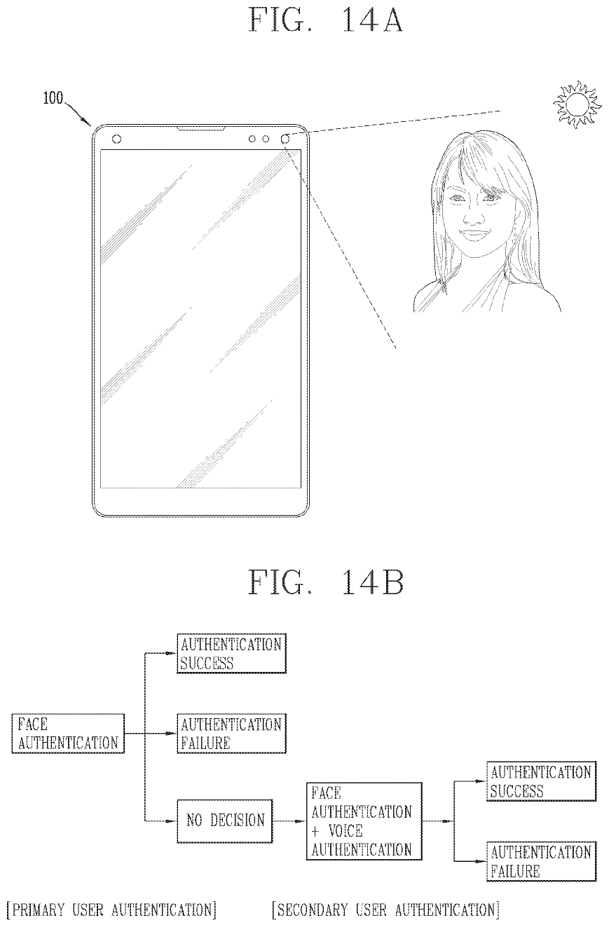

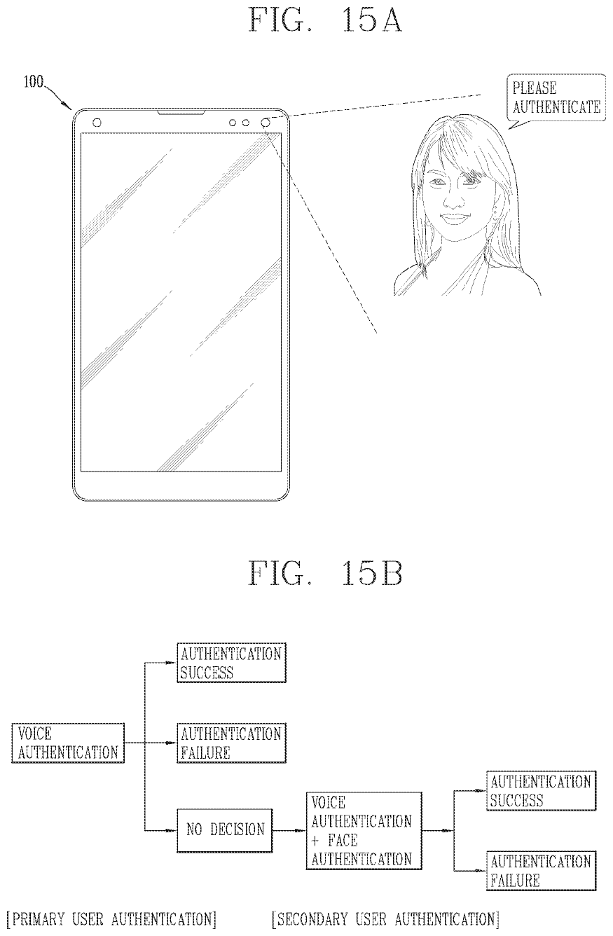

Hereinafter, a method of determining an authentication sequence in consideration of the situation information and the characteristic information of biometric information will be described in more detail. FIG. 12 is a flowchart showing a method of determining an authentication sequence of serial multimodal biometric authentication in consideration of situation information. FIGS. 13A through 14B are conceptual views for explaining the control method of FIG. 12.

The electronic device according to the present disclosure may include a first biometric sensor and a second biometric sensor to be used for biometric authentication. The first biometric sensor and the second biometric sensor may be formed to sense different biometric information. For example, the first biometric sensor is an image sensor for face authentication, and the second biometric sensor is a fingerprint sensor for fingerprint authentication.

Hereinafter, a method for determining an authentication sequence of biometric authentication in consideration of situation information in an electronic device having the first biometric sensor and the second biometric sensor will be described in more detail. Hereinafter, the description will be made base on two biometric sensors, but it will be apparent to those skilled in the art that the same method is applied to two or more biometric sensors.

First, referring to FIG. 12, the security module 181 may sense situation information at the time of recognition of the biometric information (S1210). The security module 181 senses situation information at the time of sensing at least one of first biometric information sensed through a first biometric sensor and second biometric information sensed through a second biometric sensor.

The description thereof is the same process as that of S810 of FIG. 8 described above, and thus will be replaced with the description of S810.

Furthermore, the security module 181 may determine an authentication sequence between first user authentication using the first biometric information and second user authentication using the second biometric information based on the situation information (S1220).

Specifically, the security module 181 may set an authentication sequence to first perform a biometric authentication method capable of performing biometric authentication in a faster and more convenient manner in consideration of the user's convenience.

Specifically, the security module 181 can determine the accuracy between the authentication means based on the context information. Then, the security module 181 may set the authentication sequence to first perform authentication in the order of higher accuracy.

For example, as shown in FIG. 13A, the first biometric sensor may be a voice sensor for sensing voice information, and the second biometric sensor may be an image sensor for sensing face information. The security module 181 may determine that the voice authentication has higher accuracy than the face authentication when ambient illumination is below a reference illumination.

Therefore, as shown in FIG. 13B, the security module 181 may set voice authentication for primary user authentication and perform multimodal biometric authentication fused with voice authentication and face authentication for secondary user authentication.

For another example, as shown in FIG. 14A, the first biometric sensor may be a voice sensor for sensing voice information, and the second biometric sensor may be an image sensor for sensing face information. The security module 181 may determine that face recognition has a higher accuracy than voice recognition when ambient noise is above a reference level. Accordingly, the security module 181 may set an authentication sequence to first execute the face authentication prior to the voice authentication. Accordingly, as shown in FIG. 14B, the primary user authentication may be set to perform face authentication, and the secondary user authentication may be set to perform multimodal biometric authentication fused with the face authentication and the voice authentication.

In other words, the present disclosure may set the authentication sequence in consideration of the fact that the accuracy varies according to the situation information, even with the same biometric authentication element.

In the above, a method of determining the authentication sequence in consideration of situation information has been described.

Hereinafter, a method of determining an authentication sequence of biometric authentication when two or more biometric information are sensed will be described. FIGS. 15A and 15B are conceptual views showing a method of determining an authentication sequence when at least two biometric information are acquired at the same time during serial biometric authentication.

The security module 181 may simultaneously acquire at least two biometric information from at least two biometric sensors. In this case, the security module 181 may determine biometric information to be authenticated first among at least two or more biometric information based on the characteristic information of the biometric information. Here, as described above, the characteristic information may indicate the quality of the biometric information. For example, in the case of face recognition information, the quality may be a resolution of the face recognition information, and in the case of voice information, it may be a signal-to-noise ratio.

In one embodiment, as shown in FIG. 15A, the security module 181 may acquire face recognition information through an image sensor, and acquire voice information through a voice sensor at the same time. In this case, the security module 181 may determine biometric information to be authenticated first between the face recognition information and the voice information based on the resolution information of the face recognition information and the signal-to-noise ratio information of the voice information.

In order to determine the biometric information to be authenticated first, the security module 181 may convert the resolution of the face recognition information and the signal-to-noise ratio of the voice information into a standardized quality score according to a preset criterion. Then, the security module 181 may set authentication to be carried out from higher scored biometric information based on the standardized quality score. Here, various previously known methods may be used for the preset criterion converted into the standardized quality score, and the detailed description thereof will be omitted. As shown in FIG. 15B, when the quality score of the face recognition information is higher than the voice information, the security module 181 may set face recognition using the face recognition information as primary user authentication for performing biometric authentication first. Then, the security module 181 may set multimodal biometric authentication using fusion information fused with the face recognition information and the voice information as secondary user authentication.

Alternatively, although not shown, when at least two biometric information are acquired, the security module 181 may determine biometric authentication information to be authenticated first according to a sensing sequence of the at least two biometric information. For example, when the face recognition information is acquired (or sensed) prior to voice information, face authentication may be set as primary user authentication.

In the above, a method of setting an authentication sequence based on the quality information of the biometric authentication information has been described.

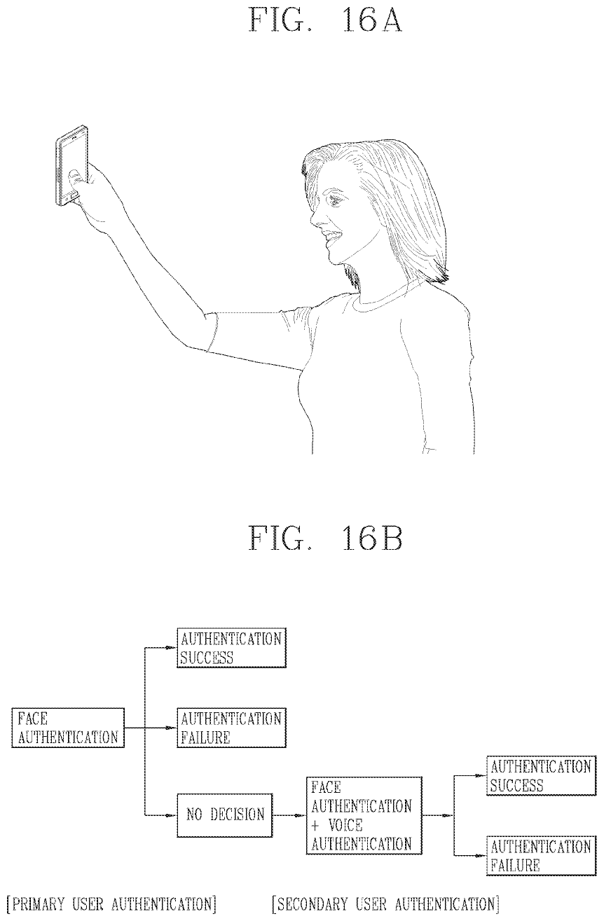

Hereinafter, a method of determining an authentication sequence according to a user gesture when at least two biometric information are acquired at the same time will be described. FIGS. 16A and 16B are conceptual views showing a method of determining an authentication sequence according to a user gesture during serial biometric authentication.

The security module 181 may sense a user gesture after at least two biometric information are acquired at the same time. At this time, the user gesture may be sensed by a gyro sensor, an acceleration sensor, and the like. The memory 170 of the electronic device may store priorities among the authentication elements for a specific user gesture. For example, for a first gesture, face authentication is set to have a higher priority than fingerprint authentication, and for a second gesture, fingerprint authentication is set to have a higher priority than face authentication.

The security module 181 may determine biometric information for performing biometric authentication first among at least two biometric information based on the priorities of the biometric information set for the user gesture.

For example, as shown in FIG. 16A, the security module 181 may sense that a user takes a gesture for lifting the main body subsequent to acquiring face recognition information and fingerprint recognition information at the same time. In the case of a gesture for lifting the main body, face authentication may be set to have a higher priority than fingerprint authentication. Accordingly, the security module 181 may set face authentication as primary user authentication.

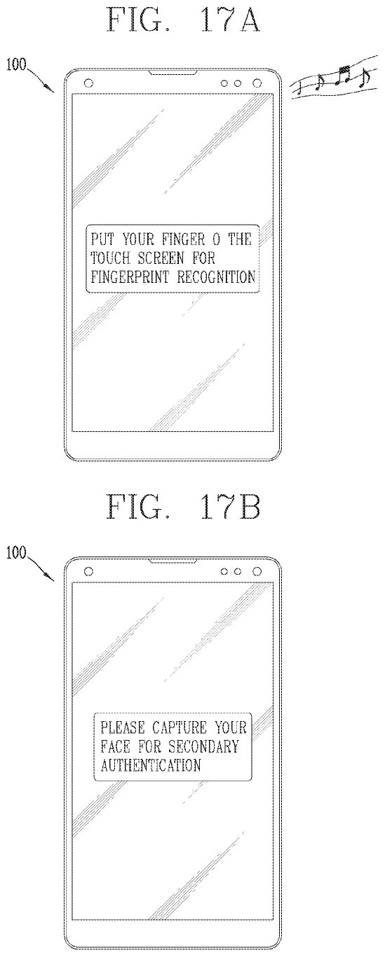

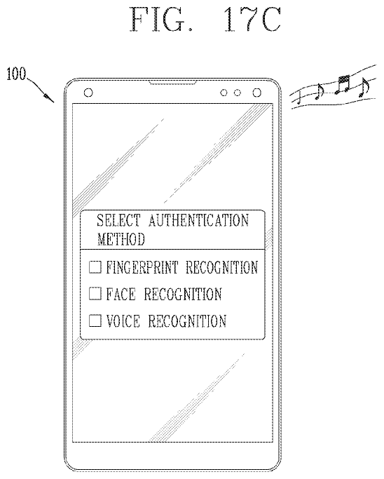

Hereinafter, a method of allowing an electronic device according to the present disclosure to provide a user interface related to multimodal biometric authentication will be described. FIGS. 17A through 17C are conceptual views showing a method of providing a user interface during serial multimodal biometric authentication.

Referring to FIG. 17A, the security module 181 may set fingerprint authentication as primary user authentication, and set fusion information fused with fingerprint recognition information and face recognition information as secondary user authentication. Furthermore, as shown in FIG. 13A, the security module 181 may display notification information related to an authentication element for performing authentication first on the touch screen. In addition, as shown in FIG. 17B, when the primary user authentication is determined as a “no decision” state to perform the secondary user authentication, the security module 181 may display notification information related to face authentication for the secondary authentication on the touch screen.

Therefore, the user may intuitively recognize information on an authentication element to be currently carried out through visual information.

On the other hand, the user may directly select the authentication element. In this case, as shown in FIG. 17C, the security module 181 may display a list including a plurality of authentication elements that are selectable by the user on the touch screen. Accordingly, the user may select at least two biometric authentication elements from the list to perform multimodal biometric authentication.

The electronic device according to the present disclosure may determine at least one of a biometric authentication method and a biometric authentication sequence in consideration of a surrounding environment at the time of executing biometric authentication, and perform multimodal biometric authentication according to the determined biometric authentication method and biometric authentication sequence, thereby enhancing user convenience for biometric authentication.

Furthermore, the electronic device according to the present disclosure may determine whether to perform secondary authentication according to the result of performing primary authentication, thereby enhancing an authentication speed of the biometric authentication.

In addition, the electronic device according to the present disclosure may perform complex authentication in secondary authentication when serial authentication is carried out, thereby enhancing the accuracy of biometric authentication.

The foregoing present disclosure may be implemented as codes readable by a computer on a medium written by the program. The computer-readable media includes all types of recording devices in which data readable by a computer system can be stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include the controller 180 of the electronic device. The foregoing embodiments are merely exemplary and are not to be considered as limiting the present disclosure. The scope of the invention should be determined by reasonable interpretation of the appended claims and all changes that come within the equivalent scope of the invention are included in the scope of the invention.

What is claimed is:

1. An electronic device configured to perform biometric authentication for executing a function, the device comprising:
a memory configured to store information;
a plurality of sensors configured to receive biometric information;
a controller configured to:
receive contextual information from one or more of the plurality of sensors;
receive first biometric information from a first sensor of the plurality of sensors;
perform a first biometric authentication comprising a generated similarity value between the received first biometric information and first biometric user information stored in the memory, wherein the first biometric authentication uses a first comparison threshold which varies based on the received contextual information;
when the first biometric authentication is successful, execute the function according to the successful authentication;
when the first biometric authentication is unsuccessful, perform a second biometric authentication using a second biometric information received from a second sensor of the plurality of sensors; and
when a result of the first biometric authentication cannot be determined, perform a third biometric authentication using a third biometric information received from a third sensor of the plurality of sensors.

2. The electronic device of claim 1, wherein the first biometric authentication uses:
the first comparison threshold corresponding to a minimum false acceptance rate; and
a second comparison threshold corresponding to a minimum false rejection rate.

3. The electronic device of 2, wherein the result of the first biometric authentication cannot be determined when the generated similarity value is higher than the second comparison threshold but lower than the first comparison threshold.

4. The electronic device of 1, wherein the contextual information comprises a detected level of ambient light.

5. The electronic device of 4, wherein:
the first biometric authentication comprises facial recognition of a user;
the second biometric authentication comprises palm recognition of the user; and
the third biometric authentication comprises fingerprint recognition of the user.

6. The electronic device of claim 1, wherein the second biometric authentication uses both the first and second biometric information.

7. The electronic device of claim 6, wherein the second biometric authentication performs user authentication by combining a comparison result obtained through comparing first biometric authentication and previously registered user information with a comparison result obtained through comparing second biometric authentication and the previously registered user information using a preset algorithm.

8. The electronic device of claim 1, further comprising:
a touch screen configured to display visual information,
wherein the controller displays visual information related to the first or second biometric authentication to be performed earlier on the touch screen.

9. The electronic device of claim 8, wherein when remaining authentication process is carried out, the controller causes the touch screen to display visual information related to the remaining authentication process.

10. An electronic device configured to perform biometric authentication for executing a function, the device comprising:
a memory configured to store information;
a plurality of sensors configured to receive biometric information;
a controller configured to:
receive contextual information from one or more of the plurality of sensors;
receive first biometric information from a first sensor of the plurality of sensors;
perform a first biometric authentication comprising a generated similarity value between the received first biometric information and first biometric user information stored in the memory, wherein the first biometric authentication uses a first comparison threshold which varies based on the received contextual information;
when the first biometric authentication is successful, execute the function according to the successful authentication;
when the first biometric authentication is unsuccessful, perform a second biometric authentication using a second biometric information received from a second sensor of the plurality of sensors; and
when a result of the first biometric authentication cannot be determined, select another biometric authentication from a plurality of biometric authentication and perform the selected another biometric authentication.

11. The electronic device of claim 10, wherein the first biometric authentication uses:
the first comparison threshold corresponding to a minimum false acceptance rate; and
a second comparison threshold corresponding to a minimum false rejection rate.

12. The electronic device of claim 11, wherein the result of the first biometric authentication cannot be determined when the generated similarity value is higher than the second comparison threshold but lower than the first comparison threshold.

13. A method of controlling an electronic device that performs biometric authentication for executing a function, the method comprising:
receiving contextual information from one or more of a plurality of sensors;
receiving first biometric information from a first sensor of the plurality of sensors;
performing a first biometric authentication comprising a generated similarity value between the received first biometric information and first biometric user information stored in a memory of the electronic device, wherein the first biometric authentication uses a first comparison threshold which varies based on the received contextual information;
when the first biometric authentication is successful, executing the function according to the successful authentication;
when the first biometric authentication is unsuccessful, performing a second biometric authentication using a second biometric information received from a second sensor of the plurality of sensors; and
when a result of the first biometric authentication cannot be determined, performing a third biometric authentication using a third biometric information received from a third sensor of the plurality of sensors.

14. The method of claim 13, wherein the first biometric authentication uses:
the first comparison threshold corresponding to a minimum false acceptance rate; and
a second comparison threshold corresponding to a minimum false rejection rate.

15. The method of claim of 14, wherein the result of the first biometric authentication cannot be determined when the generated similarity value is higher than the second comparison threshold but lower than the first comparison threshold.
